(19) United States
(12) Patent Application Publication
(10) Pub. No.: US 2026/0029268 A1
(43) Pub. Date: Jan. 29, 2026

(54) LEVEL SENSOR

(71) Applicant: WIKA Alexander Wiegand SE & Co. KG, Klingenberg/Main (DE)

(72) Inventors: Alexander LIMBERGER, Heusenstamm (DE); Lars GOETTL, Elsenfeld (DE); Alexander WILL, Laudenbach (DE); Benchi HUANG, Suzhou (CN); Bo WANG, Suzhou (CN); Yu CHENG, Suzhou (CN); Maximilian RAITZ, Luetzelbach (DE); Xinxiang TANG, Suzhou (CN); Johannes ECK, Buergstadt (DE)

(73) Assignee: WIKA Alexander Wiegand SE & Co. KG, Klingenberg/Main (DE)

(21) Appl. No.: 19/279,323

(22) Filed: Jul. 24, 2025

(30) Foreign Application Priority Data
Jul. 25, 2024 (CN) 2024-11003277.X

(51) Int. Cl. G01F 23/14

(52) U.S. Cl. CPC G01F 23/14

(57) ABSTRACT

A level sensor includes a housing and at least one sensor that is designed to measure a pressure of a medium and that is electrically connected to evaluation electronics. The level sensor also includes a connection cable that is guided through the housing in a sealing section. At least one crimp sleeve is pressed around the connection cable in the sealing section inside the housing. A pressing element is fastened in the sealing section of the housing in such a way that the crimp sleeve is pressed against a sealing surface of the sealing section. The housing or at least the sealing section of the housing is at least partially filled with a first casting, and the casting encloses the connection cable, at least in sections.

This nonprovisional application claims priority under 35 U.S.C. § 119(a) to Chinese Patent Application No. 2024-11003277.X, which was filed in China on Jul. 25, 2024, and which is herein incorporated by reference.

### FIELD OF THE INVENTION

The invention relates to a level sensor for measuring filling levels.

### DESCRIPTION OF THE BACKGROUND ART

Level sensors known from the prior art typically include a pressure sensor and evaluation electronics which are situated together in a waterproof housing. Such level sensors are suspended in containers on a connection cable that is used on the one hand for fastening, and on the other hand for transmitting signals/data and supplying power, in order to measure the level (filling level) of a liquid contained therein. The level sensor, via the installed pressure sensor, detects the hydrostatic pressure of the liquid column above the suspended position of the level sensor. With knowledge of the density of the liquid or based on some other type of calibration, the pressure may be converted to a level or filling level. A cable connection, i.e., a location in the housing at which the connection cable is guided through a cable leadthrough in the housing, is generally situated opposite from a housing section at which the pressure sensor is positioned. When used as intended, which in the following discussion is understood to mean a use situation in which for the purpose of level measurement, a level sensor is suspended on its connection cable and lowered into a container, the cable connection thus points upwardly, while the pressure sensor points downwardly.

The seal between the housing with the sensor, the evaluation electronics, and the cable poses a problem. In particular for containers with high liquid levels, high pressures may act on the level sensor and thus adversely affect the seal tightness of the level sensor. Nontight level sensors may experience irreversible damage due to the inflow of liquid, resulting in failure of the measurement system.

### SUMMARY OF THE INVENTION

It is therefore an object of the present invention to provide an improved level sensor with regard to the seal tightness, which solves the stated problems. Furthermore, the object of the invention is to also provide a level sensor that is inexpensive to manufacture, and at the same time robust.

According to a first aspect of the invention a level sensor comprises a housing, a sensor, evaluation electronics, and a connection cable.

The sensor may, for example, be a piezoresistive pressure sensor, in particular an encapsulated, oil-filled piezoresistive pressure sensor, or a pressure sensor having some other design. The housing may include one or more housing parts. The connection cable, or one end of the connection cable, is guided into or through a cable leadthrough of the housing and electrically connected to the evaluation unit inside the housing. The connection cable may include at least two separate lines. The cable leadthrough is designed, for example, as a circular opening or through hole through a housing wall. In addition, the cable leadthrough is situated at the housing in such a way that, for example, it points upwardly or is situated at least in the region of an upper end of the level sensor when the level sensor is used as intended. The sensor is likewise electrically connected to the evaluation electronics, and situated at or in the housing in such a way that it can make direct or indirect contact with a medium surrounding the level sensor in order to convert a hydrostatic pressure of the medium in the surroundings of the level sensor into a sensor signal. The housing may include a sensor carrier which during use as intended tightly seals off a downwardly pointing end of the housing, and has an opening through which the medium can make contact with the sensor, such as a piezoresistive pressure sensor mentioned above. A sensor signal is understood to mean a variable that is electrically measurable at the sensor, such as a voltage, a resistance, a current, or a capacitance. The evaluation electronics are configured to output the sensor signal of the sensor via the connection cable, and/or to calculate a measured value signal based on the sensor signal, and output this measured value signal via the connection cable.

The level sensor can include at least three barriers, i.e., a first barrier, a second barrier, and a third barrier, that are situated inside a sealing section. The sealing section is an area or housing section of the level sensor that extends from the cable leadthrough to the evaluation unit.

With regard to the cable leadthrough, a medium, for example water, that surrounds the level sensor may pass into the interior of the level sensor and to the evaluation electronics via at least two paths: The medium, starting from the cable leadthrough, may pass into the interior of the level sensor on the one hand along an inner face of the housing, and on the other hand along an outer face of the connection cable. The at least three barriers are provided and designed to effectively hinder and prevent penetration and advancement of the medium through the cable leadthrough and into the interior of the level sensor. In this way, damage to the evaluation electronics may be prevented and the service life of the level sensor may be increased.

The at least three barriers can be formed at least from a sealing element, a crimp sleeve, and a casting, which interact with one another and/or with the housing or the sealing section of the level sensor. An example of an interaction is the pressing of the sealing element against the housing, the connection cable, and the crimp sleeve. A particularly effective multistage seal may be achieved via the interaction of the above-mentioned components. The cable leadthrough already forms a first weak seal with the sheath of the connection cable. For example, the pressing of the sealing element, for example, may represent a further stage, as explained in greater detail below based on further examples.

At least the first barrier and/or the second barrier can interact with the third barrier, or can be secured against loosening by the third barrier. For example, the first and second barriers may each fulfill the function of sealing, and the third barrier, in addition to a sealing function, may also fulfill a securing function for the components of the other barriers. A securing function means, for example, the fixing or blocking of components, for example a crimp sleeve or a screw element, from loosening or slipping.

The first barrier can interact with the second barrier, and/or is additionally secured against loosening by the second barrier. As explained in greater detail below based on examples, particularly reliable, long-lasting sealing of the level sensor may be achieved in this way. At the same time, due to the interactions between the various barriers, only a small number of components is necessary for an effective seal, so that the level sensor may be easily and inexpensively manufactured.

The first barrier can be formed by pressing a sealing element against an inner wall of the housing. The first barrier may be formed by pressing the sealing element against an outer face of the connection cable. The sealing element can be pressed simultaneously against the inner wall of the housing and the outer face of the connection cable, which may be achieved particularly effectively, for example, by providing on an inner side of the cable leadthrough a groove, a recess, or an angled surface that borders the cable leadthrough, into which the sealing element is pressed. In this way, the first barrier can effectively block the two penetration paths, mentioned above, for a medium surrounding the level sensor. The sealing element may be designed as an O-ring, for example.

The level sensor can include a crimp sleeve. In this example, the second barrier can be formed on the one hand by pressing or by crimping the crimp sleeve around the connection cable, and on the other hand by pressing the crimp sleeve against a sealing surface at an inner wall of the housing or of the sealing section. Due to crimping the crimp sleeve on the connection cable, a medium surrounding the level sensor, if it should enter the housing through the cable leadthrough and overcome the first barrier, is effectively hindered from penetrating farther into the housing along an outer face of the connection cable. Due to the simultaneous pressing of the crimp sleeve against the sealing surface of the housing or of the sealing section, the medium at the same time is hindered from further advancing along an inner wall of the housing.

In an example of the level sensor, which combines the sealing element with the crimp sleeve, the first barrier may interact with the second barrier and be additionally secured from loosening by the second barrier in the following manner: For example, the sealing element is pressed between an angled surface of the housing, which borders an inner side of the cable leadthrough, the outer face of the connection cable, and a pressing surface of the crimp sleeve situated essentially orthogonally with respect to the angled surface. The sealing element is thus held in the pressed position by the crimp sleeve and prevented from slipping. At the same time, by means of the first barrier that is designed in this way, both penetration paths, mentioned above, for a medium surrounding the level sensor may be effectively blocked.

It may be provided, for example, that the crimp sleeve has a reinforced section or a sealing flange at its end facing the cable leadthrough, as a result of which a sealing contact with the sealing surface and with the sealing element may be effectively achieved.

The pressing force necessary for pressing the crimp sleeve against the sealing surface can be transferred to the crimp sleeve via a pressing element. At the same time, this pressing force may then be transferred from the crimp sleeve to the sealing element, if it is present. In the pressed state of the crimp sleeve, the pressing element ensures both the position of the crimp sleeve and the applied pressing force. The pressing element may have, for example, a screw element, a threaded sleeve, which has a screw lock. Alternatively, the pressing element in the pressed state may be welded to the housing. A circumferential weld has the advantage that a complete seal is possible. In the pressed state, the sealing element is directly secured against loosening by the crimp sleeve. Indirect securing of the sealing element then takes place, starting from the pressing element via the crimp sleeve.

The third barrier can be formed by a first casting with the sealing section, the housing, or at least one housing part. For this purpose, a casting material is filled into the housing or a housing part of the level sensor, so that the sealing section is filled with the first casting, at least in sections, and the connection cable is enclosed at least in sections. Due to the first casting, on the one hand a seal against penetrating media is effectively achieved. On the other hand, by use of this example it may be effectively achieved that the first barrier and/or the second barrier interact(s) with the third barrier and/or are/is additionally secured against loosening by the third barrier. For this purpose, the first casting may cover or enclose, at least in sections, the elements or components of the first and second barriers, for example the sealing element, the crimp sleeve, and/or the pressing element from the preceding examples. Due to the cured casting material of the first casting, warpage and reduction of the sealing effect of the other barriers are effectively prevented via an integral bond and/or form fit. The elements or components of the other barriers are in particular effectively secured against loosening and slipping.

The level sensor can include a fourth barrier. The fourth barrier can be formed by a swelling material that is provided in the connection cable. When the swelling material comes into contact with the medium surrounding the level sensor, in particular water, it swells up, thus enabling further reinforcement of the seal of the housing. In conjunction with the examples mentioned above, it is thus possible, for example, to achieve more effective pressing with the crimp sleeve and to improve the seal.

According to a second aspect of the invention, a level sensor likewise comprises a housing, a sensor, evaluation electronics, and a connection cable.

All explanations provided in the context of the invention and its examples with regard to the housing, the sensor, the evaluation electronics, and the connection cable are analogously also applicable to the corresponding parts of the level sensor according to further examples of the invention.

According to a second aspect of the invention the level sensor has a sealing section of the housing, at least in sections, between the cable leadthrough and the evaluation electronics. In the sealing section a crimp sleeve is pressed around the connection cable. In addition, a pressing element is fastened in the sealing section of the housing in such a way that the crimp sleeve is pressed against a sealing surface of the sealing section by the pressing element. The sealing surface may, for example, have a flat surface and/or may merge into a radius. In addition, the housing or at least the sealing section of the housing is at least partially filled with a first casting, and the first casting encloses the connection cable, at least in sections.

The first casting together with the crimp sleeve, the pressing element, the connection cable, and the housing establishes a form-fit connection, at least in sections. Particularly reliable sealing of the level sensor is achieved due to pressing the connection cable by the crimp sleeve, pressing the crimp sleeve against the sealing surface of the housing, and filling with the casting material of the first casting. In addition, the crimp sleeve may fulfill the function of strain relief for the connection cable. Furthermore, the crimp sleeve and the pressing element may also be completely enclosed by the first casting, which improves the seal while at the same time securing the crimp sleeve and the pressing element from loosening or slipping.

The connection cable can extend substantially in or parallel to an axis of symmetry of the housing and/or is guided in the connection cable in ventilation tubes. For example, the shape of the housing is essentially a rotationally symmetrical cylinder, and the connection cable is guided through the circular cable leadthrough, which has its midpoint in the axis of symmetry of the housing. The ventilation tube is provided for relative pressure measurement. Furthermore, in this example it may be provided that the connection cable includes a strain relief element and/or swelling material. For example, glass fiber yarns, fabric inserts made of metal or glass fibers, or other fillers may be provided. In addition, the connection cable may additionally or alternatively include a grounding braid. In conjunction with examples of both aspects of the invention, each of which includes the crimp sleeve, the grounding of the level sensor may be provided via the crimp sleeve, for example, which is pressed against the sealing surface of the housing or of the sealing section. The housing or the two housing parts is/are made of stainless steel or some other metallic material. The connection cable contains the grounding braid, which during installation of the level sensor is folded around on the exterior sheath of the connection cable. The crimp sleeve is arranged around the connection cable, and an electrical connection is established between the grounding braid on the exterior sheath and the crimp sleeve when the crimp sleeve is pressed. The electrical connection with the housing is established by pressing the crimp sleeve against the sealing surface and/or by contacting the crimp sleeve with the pressing element, which likewise is made of a conductive material. Particular surface features, rough areas, channels, or rotationally symmetrical elevations may assist with a durable electrical connection at this location.

The connection cable can have a sheath that encloses at least two lines. The sheath of the connection cable can be completely enclosed by the first casting in the housing interior or in the sealing section, and the lines of the connection cable are enclosed by the first casting, at least in sections. This may be achieved in that the lines are longer than the sheath; i.e., they protrude beyond one end of the sheath. The sheath can be completely enclosed by the first casting, and the lines are only partially enclosed, up to the connection to the evaluation electronics. The penetration/drawing in of moisture through the connection cable into the housing interior may thus be prevented.

The crimp sleeve can be a stainless steel turned part or stainless steel sheet metal part, or a galvanized, tin-plated, chrome-plated, or chromated sheet metal part made of a steel or a brass alloy or copper alloy. This type of crimp sleeve may be inexpensively manufactured, and at the same time is characterized by stability. If the housing or at least one housing part at or in which the sealing surface is formed is likewise made of a metallic material, a particularly reliable metallic seal may be achieved by pressing the crimp sleeve against the sealing surface.

The crimp sleeve may have at least two different wall thicknesses. For example, the wall thickness in a section of the crimp sleeve for pressing against the connection cable is less than in a section of the crimp sleeve that is pressed by the pressing element against the sealing surface of the housing. The crimp sleeve may have a sealing flange that is designed to press against the sealing surface.

In addition, surface treatment of the crimp sleeve or of the housing may be provided. The adhesion between the first casting, the crimp sleeve, and the housing may be increased by roughening the surface. Furthermore, a textured or roughened inner face of the crimp sleeve has a positive effect on the pressing against the connection cable. The connection can withstand higher tensile stresses on the connection cable.

A groove or recess can be formed between the cable leadthrough, the sealing surface, or the housing, and the pressed crimp sleeve in a pressed state between the crimp sleeve and the housing or the sealing surface in the sealing section. An O-ring or a molded seal or a sealing element with sealing contours is mounted in the groove or the recess, and pressed by the crimp sleeve or the pressing element. Use of an O-ring or a molded seal improves the sealing of the level sensor.

An internal thread can be provided at the sealing section, at least in sections, and the pressing element can be designed as a screw element with a corresponding external thread and is screwed into the internal thread. The crimp sleeve may thus be pressed against the sealing surface of the sealing section in a particularly simple and effective manner by the pressing element: Due to the design as a screw element, it is possible to press the crimp sleeve against the sealing surface in the sealing section of the housing with a defined pressing force. In further examples or refinements of both aspects of the invention in which the sealing element or the O-ring is additionally provided, as explained in the preceding paragraph, this pressing force also has a direct effect on the pressing of the sealing element or O-ring in the groove or recess. To keep the screw element from coming loose on its own, the pressing element may be completely enclosed or covered by the first casting. The pressing element may be designed as an insert screw, for example. The internal thread in the sealing section additionally improves the form-fit connection and adhesion of the first casting. Due to the threads that are still exposed after the pressing element is screwed in, small undercuts are created, with which the first casting forms a form-fit connection that adheres particularly well, thus greatly increasing the sealing effect.

The housing can include a first housing part and a second housing part, the connection cable being guided in the first housing part, and the sensor and the evaluation electronics being situated in the second housing part. A two-part housing allows particularly simple manufacture of the two housing parts as separate modules which are joined together in the final assembly step. The term “guided in the first housing part” can mean, for example, that the first housing part includes the cable leadthrough; i.e., the connection cable first penetrates into the first housing part and passes through it in order to be connected to the evaluation electronics.

The first housing part and/or the second housing part of the level sensor may have a cylindrical design. For example, the housing or the housing parts is/are produced by turning and/or milling from a solid material, for example stainless steel, or by cutting from a tube material. The housing parts may, for example, be pressed and/or welded together to form a one-part housing. Stainless steel containing the alloying elements chromium, nickel, and molybdenum, due to its rustproof properties, is particularly well suited for use in liquids such as water, wastewater, or salt water.

The first housing part can be at least partially filled with the first casting, and/or the second housing part is at least partially filled with a second casting. Since the housing parts accommodate different components of the level sensor, different requirements with regard to seal tightness or strength may be imposed on a respective casting. Such different requirements may be advantageously met by using two different casting materials.

The casting material for the first housing part, i.e., the first casting, may be a two-component adhesive or an epoxy resin, for example. The casting material for the second housing part, i.e., the second casting, may be a two-component liquid silicone rubber or a thermoplastic elastomer (TPE), for example.

The housing can include a sensor carrier with two pins, the two pins being situated on the sensor carrier and extending in parallel to a longitudinal axis and/or axis of symmetry of the level sensor. At the same time, the evaluation electronics include a circuit board that is situated perpendicular to the sensor carrier. “Perpendicular to the sensor carrier” may mean that the circuit board extends substantially or in parallel to the two pins. Contacting of the circuit board to the sensor is designed as a plug connection between contact pins of the sensor, which are present in particular in piezoresistive encapsulated, oil-filled pressure sensors, and corresponding sockets that are soldered to the circuit board. At the same time, the two pins are flatly soldered to the circuit board, as a result of which the circuit board is fixed and held relative to the sensor carrier via the pins. In this way the plug connection between the sensor and the circuit board may be mechanically relieved of strain and protected. A particularly low-stress mechanical connection is possible due to the plug connection between the circuit board and the sensor. For example, temperature-related mechanical stresses may be compensated for particularly well. By use of a subsequent soldering process or heating process, the already inserted sockets may once again be centered with respect to their respective contact pins, resulting in equivalent contact forces at the contact points which cancel one another out. Furthermore, it may also be provided that the two pins can be welded to the sensor carrier. The weld connection is a particularly stable integrally joined connection, and increases the load capacity of the level sensor, for example with respect to impact loads or vibrations that occur during installation or operation.

The level sensor can include a housing, and a sensor that is sealingly situated at a sensor carrier and connected to evaluation electronics. In addition, the level sensor includes a connection cable with at least two lines that are connected to the evaluation electronics. At least two pins can be situated on the sensor carrier, in parallel to a longitudinal axis of the level sensor. The evaluation electronics can include a circuit board that is situated substantially or perpendicular to the sensor carrier. The circuit board is joined to the two pins via flat solder connections. The contacting of the evaluation electronics or the circuit board to the sensor is designed as a plug connection. Contact pins of the sensor are inserted into corresponding sockets, which are soldered to the circuit board. A particularly low-stress mechanical connection is possible due to the plug connection between the circuit board and the sensor. For example, temperature-related mechanical stresses may thus be compensated for particularly well. By use of a subsequent soldering process or heating process, the already inserted contacts may once again be centered with respect to their pins, resulting in equivalent contact forces at the contact points which cancel one another out.

At least two pins can be welded to the sensor carrier. The weld connection is a particularly stable integrally joined connection, and increases the load capacity of the level sensor, for example with respect to impact loads that occur during installation or operation.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a level sensor,

FIG. 2A shows an example of an upper housing part of a level sensor,

FIG. 2B shows an example an upper housing part of a level sensor, and

FIG. 2C shows an enlarged detail from FIG. 2B.

### DETAILED DESCRIPTION

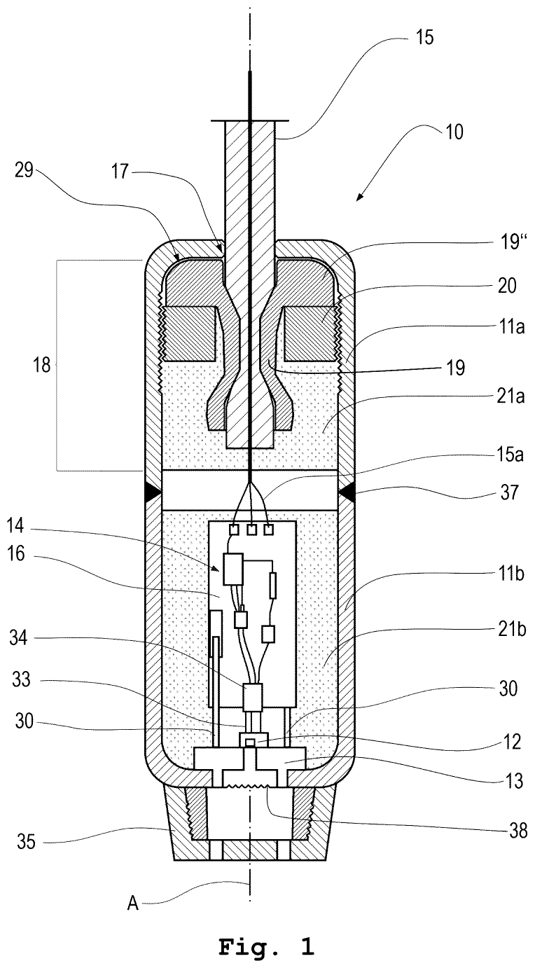

An example of a level sensor 10 is illustrated in FIG. 1. The level sensor 10 includes a housing 11 with a first housing part 11a and a second housing part 11b. The first, upper housing part 11a is circumferentially welded to the second, lower housing part 11b (circumferential weld seam 37).

A connection cable 15 is guided into the first housing part 11a via a cable leadthrough 17. The connection cable 15 may include one or more litz wires 15a. In the sealing section 18 a crimp sleeve 19 is pressed against the connection cable 15. The cross section of the connection cable 15 is tapered in the area of the crimping. A pressing element 20 is used to additionally press a reinforced section or sealing flange 19″ of the crimp sleeve 19 against a sealing surface 29. The sealing surface 29 may extend from the horizontal region, across the radius of the housing 11a, to the vertical sealing section 18. After the crimping of the connection cable 15 and the pressing of the crimp sleeve 19 against the sealing surface 29 of the housing part 11a by the pressing element 20, the first housing part 11a is filled with a first casting 21a in the region of the sealing section 18.

In the second housing part 11b a sensor 12 is situated on a sensor carrier 13. The midpoints of the sensor 12 and of the sensor carrier 13 intersect an axis A. A protective cap 35 protects a diaphragm 38 from damage. Two pins 30 are welded to the sensor carrier 13 in the radial direction and parallel to the axis A. Each pin 30 is flatly soldered to a solderable surface of the circuit board 16, which is equipped with evaluation electronics 14. One pin 30 is soldered to the front side, and one pin 30 is soldered to the rear side. Other designs, for example soldering both pins 30 to only one surface of the circuit board 16, are also conceivable.

An electrical connection of the sensor 12 to the circuit board 16 and in particular to the evaluation electronics 14 is established via plugs 33 and sockets 34. The pins of the sensor 12 have the function of the plug(s) 33. The sockets 34 corresponding to the plugs 33 are soldered to the circuit board 16. Strip conductors connected in this way establish the electrical connection to the electronic components (only schematically indicated here). The electrical connection to the connection cable 15 takes place at the upper end of the circuit board 16. The second housing part 11b is cast with a second casting 21b.

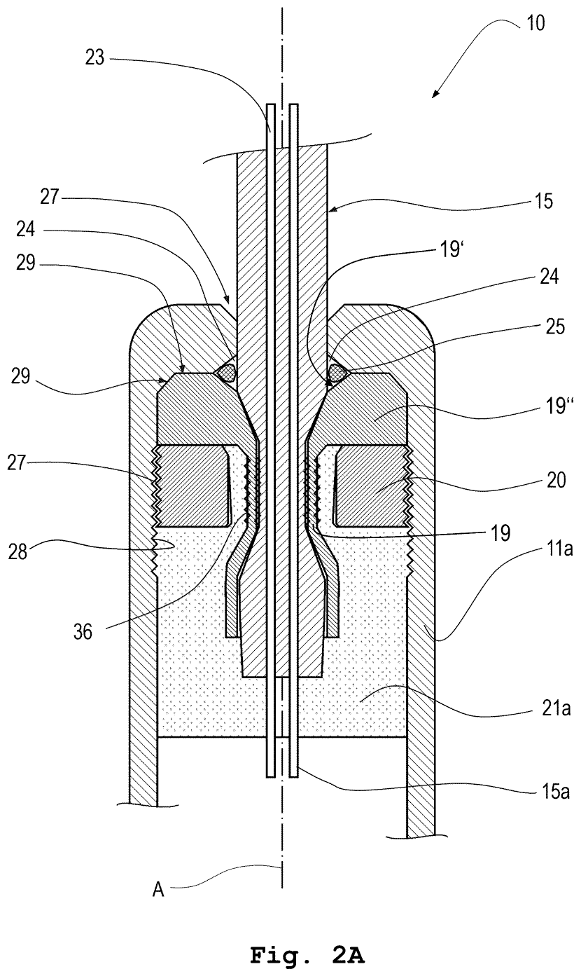

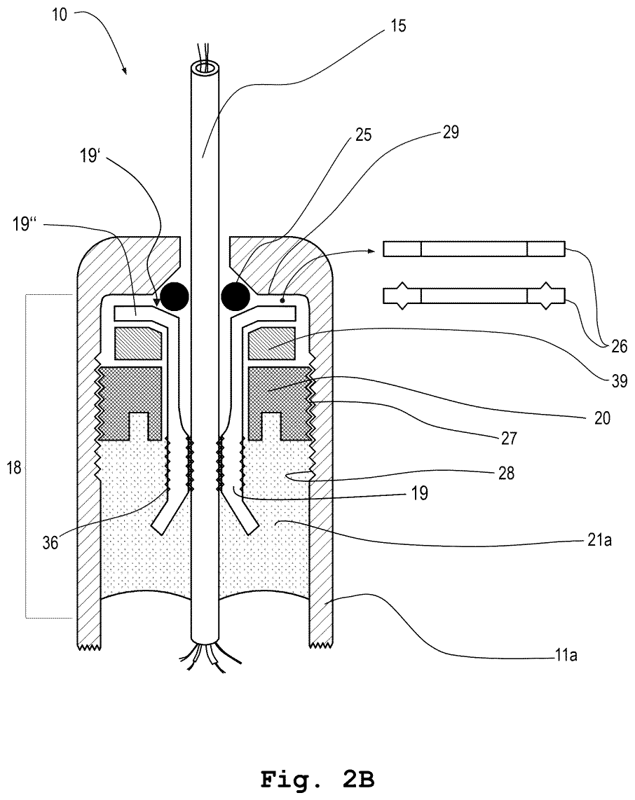

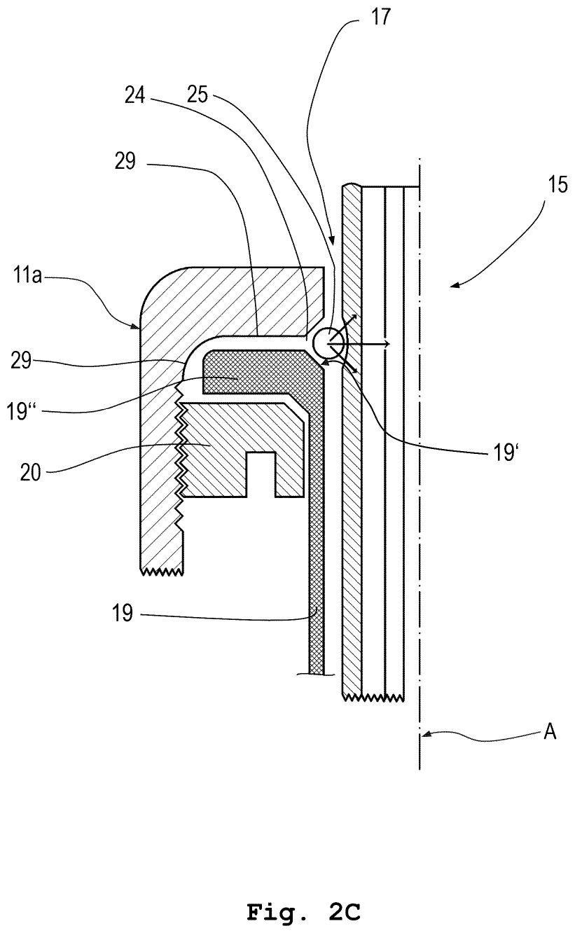

The first, upper housing part 11a is illustrated in greater detail in an enlarged scale in FIG. 2A. The connection cable 15 is guided into the housing 11a via the cable leadthrough 17. One or more litz wires 15a and a ventilation tube 23 are present in the connection cable 15. In the region of the pressing of the crimp sleeve 19, the cross section of the connection cable 15 is reduced in comparison to an unpressed section. In addition, the region of the crimp sleeve 19 that is pressed may have a roughened surface. The first casting 21a adheres particularly well to this zone 36. Possible creepage distances of liquids are increased, and the seal is greatly improved. In addition, the inner side of the crimp sleeve 19 may have a textured, roughened surface to improve the tight connection to the connection cable 15.

An O-ring 25 is situated in a groove or recess 24 between the cable leadthrough 17 and a pressing surface 19′ of the crimp sleeve 19. As a result of the pressing by the pressing element 20, on the one hand a reinforced section or sealing flange 19″ of the crimp sleeve 19 is pressed against the sealing surface(s) 29, and a metallic seal is formed. On the other hand, the volume of the recess 24 is also reduced, thus pressing the O-ring 25.

In this shown example, the pressing element 20 is a screw element having an external thread 27. A corresponding mating thread 28 is traversed at the inner face of the housing part 11a. Defined pressing of the O-ring 25 is possible by tightening the screw element 20 with a fixed torque. In this way, on the one hand damage to the O-ring 25 due to material overload under an excessively high pressing force, and on the other hand an ineffective seal due to an excessively low pressing force, are avoided.

FIG. 2B shows an example of the first housing part 11a. For purposes of illustration, the components (crimp sleeve 19, O-ring 25, pressing element 20, connection cable 15) are intentionally placed slightly farther away from one another. A filling material 39 is situated between the pressing element 20 and the crimp sleeve 19. In addition, a molded seal 26 is inserted between a reinforced section or sealing flange 19″ of the crimp sleeve 19 and the sealing surface 29. The sealing effect may be further increased in this way.

FIG. 2C shows a detail of the first housing part 11a. The sealing of the cable leadthrough 17 with the O-ring 25 is discussed in greater detail below. For a clear illustration, the components (crimp sleeve 19, O-ring 25, pressing element 20, connection cable 15) have been shown spaced apart from one another.

The pressing element 20 transfers an applied force to a reinforced section or a sealing flange 19″ of the crimp sleeve 19, which is pressed against the sealing surface(s) 29, resulting in a metallic seal. The cross section of the cable leadthrough 17 of the housing part 11a increases in the direction of the crimp sleeve, and together with the pressing surface 19′ of the crimp sleeve 19 delimits the recess 24. The O-ring is thus pressed between the pressing surface 19′, a section of the cable leadthrough 17, and the connection cable 15. A contour of the recess 24 is optimally adapted to the contour of the O-ring 25 so that the O-ring 25 is subjected to uniform load, and in the pressed state practically no air inclusions occur in the gaps. Depending on the material properties and hardness of the O-ring 25 and the sheath of the connection cable 15, different degrees of pressing may be set, and therefore different sealing effects may be achieved.

The invention is not limited to the examples described above, and may be modified within the scope of the claims below. Likewise, individual aspects from the subclaims may be combined with one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A level sensor comprising:
a housing with a cable leadthrough;
evaluation electronics arranged inside the housing;
a sensor that is connectable to the evaluation electronics;
a connection cable that is insertable through the cable leadthrough and into the housing, at least in sections, and connectable to the evaluation electronics;
a sealing section of the housing is provided, at least in sections, between the cable leadthrough and the evaluation electronics, the sealing section includes a first barrier, a second barrier, and a third barrier against penetrating fluids,
wherein the first, second, and third barriers are each configured to prevent penetration and/or advancement of a medium through the cable leadthrough to the evaluation electronics.

2. The level sensor according to claim 1, wherein the first barrier interacts with the second barrier, and/or is additionally secured against loosening by the second barrier, and/or wherein the first barrier and/or the second barrier interact with the third barrier, or are additionally secured against loosening by the third barrier.

3. The level sensor according to claim 1, wherein the first barrier is formed by pressing a sealing element against the housing part and/or by pressing the sealing element against the connection cable.

4. The level sensor according to claim 3, wherein the second barrier is formed by pressing a crimp sleeve against a sealing surface of the sealing section and by pressing or crimping the crimp sleeve around the connection cable.

5. The level sensor according to claim 4, wherein the first barrier is formed by pressing the sealing element between an angled surface of the housing, a surface of the crimp sleeve arranged essentially orthogonally thereto, and the connection cable.

6. The level sensor according to claim 4, wherein a pressing force for pressing the crimp sleeve against the sealing surface is transferred by a pressing element and the pressing force is at a same time transferred to the sealing element via the crimp sleeve, and wherein the crimp sleeve and the sealing element in a pressed state are directly or indirectly secured against loosening via the pressing element.

7. The level sensor according to claim 1, wherein the housing or the sealing section is at least partially filled with a first casting, and the first casting encloses the connection cable, at least in sections, thereby forming the third barrier, and wherein the first casting prevents loosening of the components of the first and second barriers.

8. The level sensor according to claim 1, further comprising a fourth barrier that is formed by a swelling material in the connection cable which swells up upon media contact and increases pressing for the sealing.

9. A level sensor comprising:
a housing with a cable leadthrough;
evaluation electronics arranged inside the housing;
a sensor that is connectable to the evaluation electronics;
a connection cable that is insertable through the cable leadthrough and into the housing, at least in sections, and connectable to the evaluation electronics;
a sealing section of the housing is provided, at least in sections, between the cable leadthrough and the evaluation electronics, wherein in the sealing section, a crimp sleeve is pressed around the connection cable; and
a pressing element fastened in the sealing section of the housing such that the crimp sleeve is pressed by the pressing element against a sealing surface of the sealing section,
wherein the housing or the sealing section is at least partially filled with a first casting, and
wherein the first casting encloses the connection cable, at least in sections.

10. The level sensor according to claim 7, wherein the connection cable includes a sheath and at least two lines, wherein the sheath in the housing interior or in the sealing section is completely enclosed by the first casting, and wherein lines of the connection cable are enclosed by the first casting, at least in sections.

11. The level sensor according to claim 6, wherein an internal thread is provided at the sealing section, at least in sections, and wherein the pressing element is designed as a screw element with a corresponding external thread and is screwed into the internal thread.

12. The level sensor according to claim 4, wherein the crimp sleeve is a stainless steel turned part or stainless steel sheet metal part, or a galvanized sheet metal part.

13. The level sensor according to claim 4, wherein the sealing section and the crimp sleeve are designed in such a way that a groove or recess is formed between the cable leadthrough and the pressed crimp sleeve in a pressed state between the crimp sleeve and the housing or a sealing surface of the sealing section, wherein an O-ring or a molded seal or a sealing element with sealing contours is mounted in the groove or the recess, and pressed by the crimp sleeve and/or the pressing element.

14. The level sensor according to claim 1, wherein the housing includes a first housing part and a second housing part, wherein the connection cable is guided in the first housing part, and wherein the sensor and the evaluation electronics are arranged in the second housing part.

15. The level sensor according to claim 7, wherein the housing includes a first housing part and a second housing part, wherein the connection cable is guided in the first housing part, wherein the sensor and the evaluation electronics are arranged in the second housing part, and wherein the first housing part is at least partially filled with the first casting and/or the second housing part is at least partially filled with a second casting.

16. The level sensor according to claim 15, wherein the first casting is a two-component adhesive or an epoxy resin, and/or wherein the second casting is a two-component liquid silicone rubber or a thermoplastic elastomer.

17. The level sensor according to claim 1, wherein the sensor is a piezoresistive pressure sensor or an encapsulated, oil-filled piezoresistive pressure sensor.

18. The level sensor according to claim 1, wherein the housing comprises a sensor carrier with two pins, wherein the two pins are arranged on the sensor carrier and extend in parallel to a longitudinal axis/axis of symmetry of the level sensor, wherein the evaluation electronics include a circuit board that is arranged substantially perpendicular to the sensor carrier, wherein the two pins are flatly soldered to the circuit board, and wherein the contacting of the circuit board to the sensor is designed as a plug connection of contact pins of the sensor and corresponding sockets that are soldered to the circuit board.

19. The level sensor according to claim 1, wherein the connection cable extends in or substantially parallel to an axis of symmetry of the housing, and/or wherein at least one of:
a ventilation tube,
a strain relief element,
a grounding braid, and/or
a swelling material,
are guided in the connection cable.

20. A level sensor comprising:
a housing;
at least one sensor that is sealingly arranged at a sensor carrier and connectable to evaluation electronics;
a connection cable with at least two lines that are connectable to the evaluation electronics;
at least two pins arranged on the sensor carrier in parallel to a longitudinal axis/axis of symmetry of the level sensor; and
a circuit board with the evaluation electronics is arranged substantially perpendicular to the sensor carrier,
wherein the at least two pins are flatly soldered to the circuit board, and
wherein the contacting of the circuit board to the sensor is designed as a plug connection of contact pins of the sensor and corresponding sockets that are soldered to the circuit board.

21. The level sensor according to claim 20, wherein the pins are centered with respect to their socket contacts such that the contact forces at the individual contact points are in each case essentially equal, or force magnitudes in each case cancel one another out.
